(19) United States
(12) Patent Application Publication
(10) Pub. No.: US 2026/0339820 A1
(43) Pub. Date: Oct. 29, 2026

(54) HARDWARE DEBUG WITH RETRIEVAL-AUGMENTED GENERATIVE AI

(71) Applicant: Microsoft Technology Licensing, LLC, Redmond, WA (US)

(72) Inventors: Dong Hyun BAIK, Portland, OR (US); Samuel Chelsae KNIGHT, Portland, OR (US); Vanila CHINTHA REDDY, Portland, OR (US); Jarred Joseph WHITE, Portland, OR (US); Dibyendu DEY, Portland, OR (US); Charles Parker WOOD, Portland, OR (US)

(21) Appl. No.: 19/187,499

(22) Filed: Apr. 23, 2025

(51) Int. Cl. G06F 11/362; G06F 11/3668

(52) U.S. Cl. CPC G06F 11/3648; G06F 11/3688

(57) ABSTRACT

The technology described herein relates to an AI based hardware debug system providing a method including receiving a test code script for a hardware functional block, tokenizing the test code script to generate a test code vector, indexing the test code vector for storage in a cloud-based test code vector database, inputting the indexed test code vector into a language model (LM), and in response to inputting the test code into the LM, receiving from the LM a suggestion of one or more related code scripts.

### BACKGROUND

Computing systems may be implemented on system on chips (SoCs) which are a type of integrated circuit (IC) design that combines many or all high-level functional elements of an electronic device onto a single chip instead of using separate components mounted to a motherboard, as is done in traditional electronics design. Typical SoCs may include a number of hardware functional blocks, such as processors, memory units, I/O units, communication units, etc., each having a number of registers having a number of fields. Registers constitute a significant percentage of today's complex SoC designs and make up a significant portion of today’s complex SoC designs. For example, in modern SoCs, the number of registers can range into the millions or sometimes into tens of millions. To manage the SoCs, SoC debug testers are tasked with the routine creation and distribution of specialized code to verify the functionality of innovative chip designs. For example, various testers may be independently generating code specific to their validation domain, which often results in unnecessary duplication and a lack of cooperative effort.

### SUMMARY

In some aspects, the technology described herein relates to an AI based hardware debug system providing a method including receiving a test code script for a hardware functional block, tokenizing the test code script to generate a test code vector, indexing the test code vector for storage in a cloud-based test code vector database, inputting the indexed test code vector into a language model (LM), and in response to inputting the test code into the LM, receiving from the LM a suggestion of one or more related code scripts.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 discloses example code documentation components of an AI based hardware debug system disclosed herein.

FIG. 2 discloses an example schematic diagram for generating cloud-based storage of indexed code scripts for the AI based hardware debug system disclosed herein.

FIG. 3 discloses an example schematic diagram for using RAG based on the cloud-based storage of indexed code scripts for the AI based hardware debug system disclosed herein.

FIG. 4 discloses example operations of the AI based hardware debug system disclosed herein.

FIG. 5 discloses alternative example operations of the AI based hardware debug system disclosed herein.

FIG. 6 discloses yet alternative example operations of the AI based hardware debug system disclosed herein.

FIG. 7 illustrates an example of a computing device for use in implementing the described technology.

### DETAILED DESCRIPTIONS

Computing systems may be implemented on system on chips (SoCs) which are a type of integrated circuit (IC) design that combines many or all high-level functional elements of an electronic device onto a single chip instead of using separate components mounted to a motherboard, as is done in traditional electronics design. Typical SoCs may include a number of hardware functional blocks, such as processors, memory units, I/O units, communication units, etc., each having a number of registers having a number of fields. Registers constitute a significant percentage of today's complex SoC designs and make up a significant portion of today’s complex SoC designs. For example, in modern SoCs, the number of registers can range into the millions or sometimes into tens of millions.

With the rapid recent advancement of language models (LMs), a new generation of AI bots are being explored to assist these engineers by providing quick access to relevant information and bridging the gap left by tacit knowledge. As used herein, the term “language model” or LM refers to a model that is trained to interpret textual inputs and generate textual outputs. Textual inputs and outputs consist of written words, characters, symbols, and spaces that represent language, ideas, or concepts. Per the above definition, the term “language model” encompasses natural language processing (NLP) models as well as models that process other types of textual inputs, including text-based code and textual characters. Additionally, “language model” encompasses certain multimodal models that can receive prompts that include text, image, audio, and/or video data and that may generate outputs of multiple types that are not necessarily the same as the input type. Example types of language models include transformer-based models such as generative pre-trained transformer (GPT) models, Open Pretrained Transformer (OPT) models, and Bidirectional Encoder Representations from Transformers (BERT) models, as well as Bioscience Large Open-science Open-access Multilingual (BLOOM) models, seq2seq models, long short-term memory (LSTM) network, and recurrent neural networks (RNNs). Examples of publicly available multimodal language models include the Mistral AI model and the large language model Meta AI (LLaMa) model.

To manage the SoCs, SoC debug testers are tasked with the routine creation and distribution of specialized code to verify the functionality of innovative chip designs. For example, various testers may be independently generating code specific to their validation domain, which often results in unnecessary duplication and a lack of cooperative effort. While generative advancements have begun to address these challenges, the core models still fall short in harnessing detailed knowledge pertaining to product information. Consequently, responses from LMs are not as enriched as they could be, particularly in the context of hardware design and debugging, where knowledge is stringently guarded due to intellectual property constraints.

By employing a retrieval augmented generation (RAG) approach, the AI based hardware debug system disclosed herein significantly enhances the quality of prompt responses within the context of given validation goals. The methods disclosed herein have demonstrated a constructive feedback loop that continually updates other validators contribution of information, tools and methodologies, remedying its previous deficiencies. Specifically, various implementation of an AI based hardware debug system disclosed herein provide a framework that is built upon the systematic indexing of newly crafted code scripts into a cloud storage. These scripts are categorized in real-time using straightforward docstring descriptions, ensuring their immediate availability across various validation domains.

The disclosed implementations allow the testers to have control over encapsulation of the code by whether the tester include docstring or omitting it. For example, only codes with docstring may be published to be indexed and referenced by generative AI. Such dynamic indexing promotes collaborative efforts and reduces repetitive work.

Furthermore, the AI based hardware debug system disclosed herein provide a framework that incorporates generative AI technology for instantaneous code completion based on continuous sharing of grounding knowledge for generative AI. Specifically, the implementations disclosed herein receive code for hardware from testers and use generative AI to interpret the intention of the code to recommend one or more pertinent scripts from an indexed collection of code. The code received from the hardware testers may include one or more comments in the form of docstrings. In one implementation, the docstring are tokenized to generate vectors that can be indexed and stored into a cloud-based storage. Furthermore, such docstrings are also categorized in real-time using docstring descriptions. This ensures the immediate availability of code scripts across various validation domains. Example validation domains include electrical validation of input/output (I/O), memory, etc. Alternatively, functional validation domains may include functional validation of cores, memory, and other functional blocks on the SoC. The real-time nature of both indexing and code completion allows use of the indexed code scripts in the swiftly changing demands of hardware or semiconductor functional blocks. and designs characterized by brief life cycles.

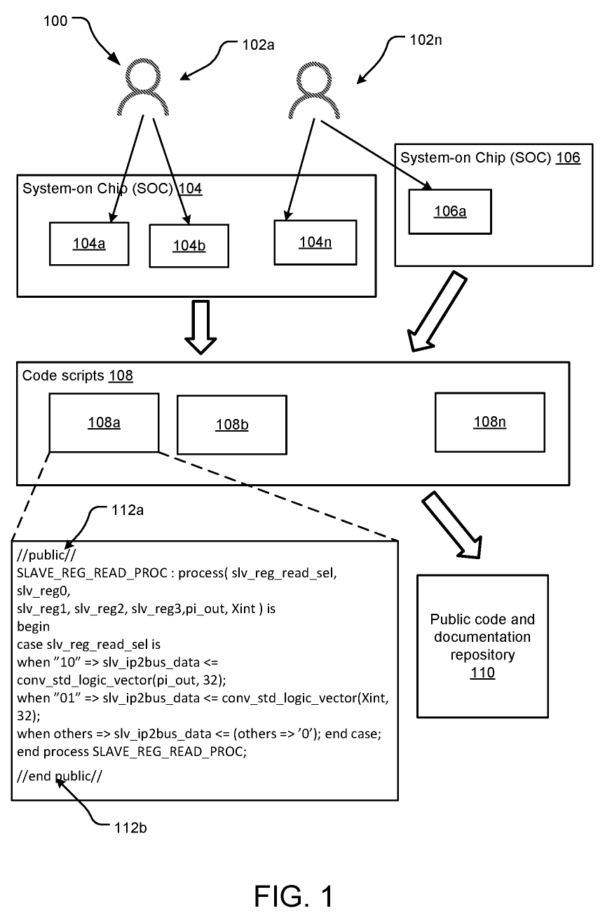

FIG. 1 discloses code documentation components 100 of an AI based hardware debug system disclosed herein. Specifically, as disclosed herein a number of test code developers 102 may be working with one or more hardware functional blocks 104a-104n on a system on chip (SoC) 104. For example, the SoC 104 may be an SoC for a computing device, a mobile device, a server, etc. The functional blocks 104a-104n on the SoC 104a may be include one or more processors, power controllers, memory blocks, input/output controllers, etc. For example, the functional block 104a may be a central processing unit (CPU), the functional block 104b may be a universal power system (UPS) controller, the functional block 106n may be a keyboard controller, etc. Other examples of functional blocks 104 may include graphical processing units (GPUs), machine learning units (MLUs), etc.

Each of the functional blocks 104a-104n may include a number of registers, switches, etc., that need to be set or programmed by the users. Furthermore, the test code developers 102 may also need to test the functioning of the one or more components of the functional blocks 104a-104n. For example, the test code developer 102a may be writing test code scripts to test one or more registers, flags, values stored in cache, etc., for the functional block 104a and 104b. Whereas the test code developer 102n may be writing test code scripts to test one or more registers, flags, values stored in cache, etc., for the functional block 104n on SoC 104 and for a functional block 106a on another SoC 106.

Thus, for example, 108a illustrates code script that may be developed by a test code developer 102a for implementing slave model software accessible register(s). In some implementations, validators may run a predetermined workload on the functional blocks and subsequently use code to check values of registers, etc., to confirm their content post-workload to determine if the functional blocks performed as expected. As illustrated, the test code developer 102a may have included a dosctring in form of comments //…// to provide a description of the test code script 108a. In the illustrated example, such docstring 112 (including the docstring 112a and 112b) may describe the test code script 108a to be a public code script.

As illustrated, there may be a number of code scripts 108 that are used for testing or debugging various functional blocks (104a-104n, 106a, etc.) of various SoCs. The AI based hardware debug system disclosed herein provides for generating a cloud-based code vector database (as further disclosed in the following figures) to code developers 102 to use AI to interpret their intentions and to recommend pertinent code scripts from an indexed collection of scripts. Specifically, the AI based hardware debug system disclosed herein separates public vs private components of various code scripts 108 by analyzing the docstrings 112 embedded by the code developers 102. Subsequently, it combines the public components of the code scripts 106 with other public documentation to generate a public code and documentation repository 110. Specifically, the public code and documentation repository 110 may store code sections identified as public from a number of code developers and for a number of different functional blocks across a number of different SoCs.

For example, the public code and documentation repository 110 may have debug code script sections for a number of CPUs, GPUs, IO controllers, memory controllers, etc. In one implementation, the debug code script sections may be limited to those for a single organization. However, alternatively public code sections of debug code scripts from a number of different organizations may also be stored in the public code and documentation repository 110. Furthermore, in alternative implementation, the public code and documentation repository 110 may also include other publicly available documentations related to the various functional blocks, such as factory specification, user guides, etc. The information stored in the public code and documentation repository 110 may be used, as further discussed below, to generate a cloud-based storage of indexed code scripts.

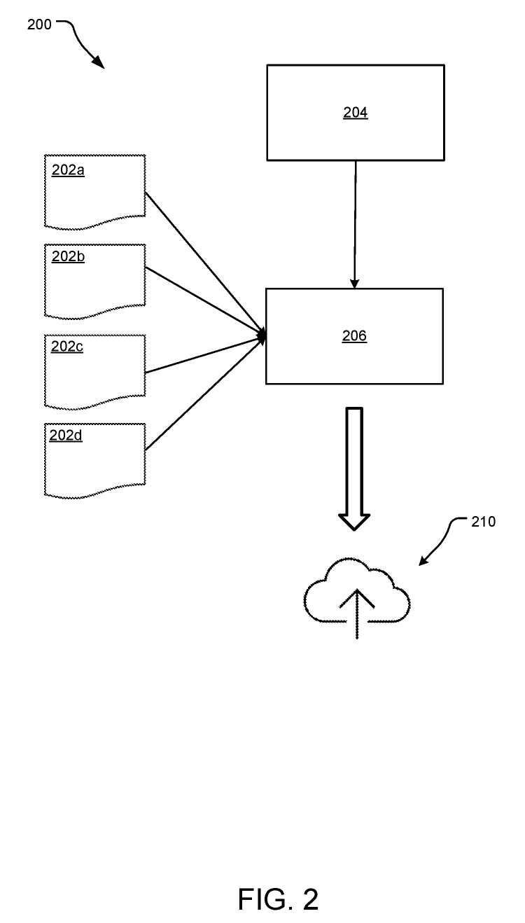

FIG. 2 discloses a schematic diagram 200 for generating a cloud-based storage 210 of indexed code scripts for the AI based hardware debug system disclosed herein. Specifically, an extraction and consolidation engine 206 may extract information from a number of different sources to generate the cloud-based storage 210 (also referred to as a cloud-based test code vector database 210). For example, the extraction and consolidation engine 206 may extract information from hardware specifications 202a for various functional blocks such as CPUs offered by various vendors, GPUs from various vendors, etc.

Additionally, the extraction and consolidation engine 206 may extract information from validation plan documents 202b for various functional blocks. For example, such validation plan documents 202b may specify plan for validating various input/output/processing functionalities of one or more functional blocks. In one implementation, such validation plan documents 202b may be limited to public validation plan documents. Alternatively, versions of internal validation plan documents may also be used for the AI based hardware debug system used for internal use.

As another example, the extraction and consolidation engine 206 may also extract data from a repository of validation coding conventions 202c or other sources 202d pertinent to validation and testing of various functional blocks. Furthermore, the extraction and consolidation engine 206 also extracts information from a public code and documentation repository 204 that stores public components of a number of code scripts. An example of such public code and documentation repository 204 is the public code and documentation repository 110 disclosed in FIG. 1.

The extraction and consolidation engine 206 may tokenize the information extracted from the various sources to generate tokenized vectors. Tokenizing the information may include converting the corpus of words into numbers based on a predetermined algorithm and then generating vectors of the generated numbers such that distance between various vectors may be determined. For example, such tokenized vectors include test code vectors generated from tokenizing test code scripts extracted from the various sources 202 and the public code and documentation repository 204. Subsequently, the extraction and consolidation engine 206 may index the tokenized vectors based on number of various indexes. Such indexing the tokenized vectors may include indexing based on the type of functional blocks (CPUs, GPUs, etc.) for which the test code scripts are written. Alternatively, the test code vectors may be indexed based on the type of SoCs (mobile device SoC, laptop SoC, etc.) on which the functional blocks are configured. The indexed vectors are stored in the cloud-based test code vector database 210.

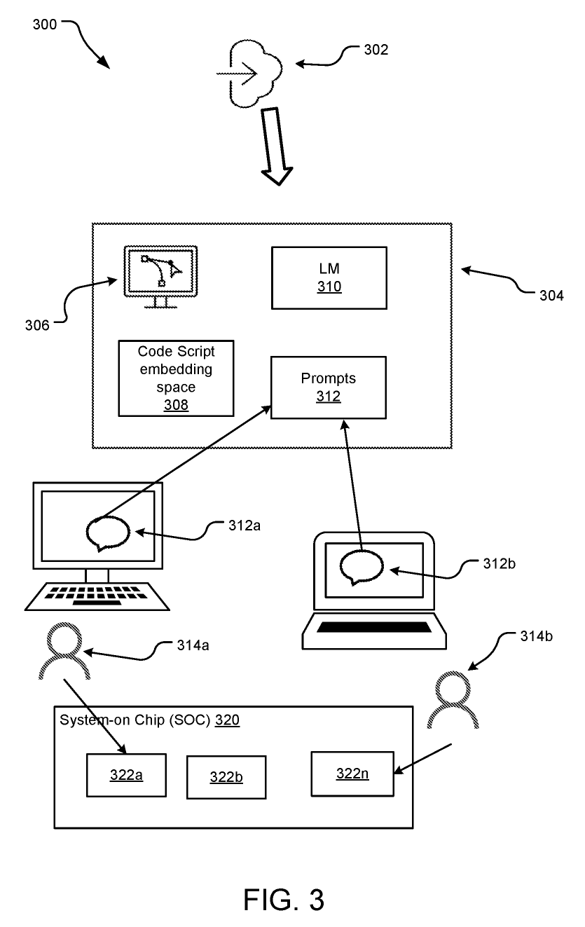

FIG. 3 discloses a schematic diagram 300 for using RAG on the cloud-based storage of indexed code scripts for the AI based hardware debug system disclosed herein. Specifically, FIG. 3 illustrates a RAG engine 304 that uses a test code vector database 302 to respond to user prompts from various users. The RAG engine 304 may include search indexes 306 that are generated based on the test code vector database 302.The RAG engine 304 may also include an LM 310 that is trained using the test code vector database 302.

By employing a retrieval augmented generation (RAG) approach, the RAG engine 304 first embeds each of the indexed code script documents into a code script embedding space 308. Subsequently, using the user 314’s prompts 312 (question or code script), it then selects top-k most relevant documents from the code script embedding space 308 (e.g., based on distance between embedding vectors, full text search), augments the original user prompt 312 with these documents, and prompts the LM 310 to obtain a final answer. Subsequently, the final answer generated by the LM 310 is presented to the user.

As an example, test code developers 314a, 314b (together referred to as test code developers 314) may interact with the RAG engine 304 to facilitate debug test code for various functional blocks 322 on an SoC 320. For example, a user 314a may be developing a debug test code for a CPU 322a and it may generate a prompt 312a that is input as part of the prompts 312 of the RAG engine 304. As an example, the prompt 312a may be a request to receive debug test code script for a flag in the functional block 322a.

Alternatively, the user 314b may be developing debug test code for a GPS controller functional block 322n. As an example, the prompt 312b from the user 314b may be partial test code script for the GPS controller functional block 322n. In this case, the RAG engine 304 may return a number of top code completion options, as generated by the LM 310 to the user. The instantaneous nature of both indexing 306 and code completion presented to the users aligns perfectly with the swiftly changing demands of semiconductor functional blocks and designs characterized by brief life cycles.

The hardware debug system using RAG expedites development of debug test code, encourages cooperative work, facilitates the exchange of knowledge, and enhances productivity within the dynamic realm of SoCs using semiconductor functional blocks. Specifically, this framework signifies a change in the methodology of validation testers in code creation, propelling unparalleled efficiency in the field of semiconductor technology. Furthermore, these implementations leverage RAG to enhance the quality of prompt responses, specifically tailored to validation goals in semiconductor development. Furthermore, as a result of using indexing 306 in the RAG engine 304, newly crafted code scripts are indexed in real-time with docstring descriptions, ensuring immediate availability and reducing redundancy across validation domains. Additionally, allowing the users to provide prompts 312 that are processed by the RAG engine 304, it provides a continuous feedback loop, updating code developer and validators’ contributions and methodologies, thus remedying previous deficiencies and promoting collaborative efforts. Additionally, allowing users to provide docstrings to identify code sections, the implementations disclosed herein fosters sharing confidential design and debug information within secure boundaries, thus enhancing productivity and allowing conformity with rapid changes to the designs of semiconductor functional blocks.

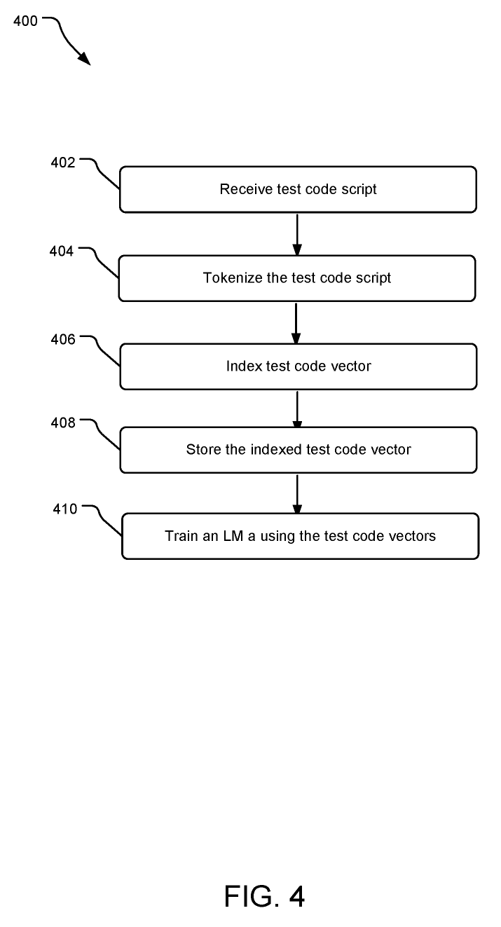

FIG. 4 discloses operations 400 of the AI based hardware debug system disclosed herein. An operation 401 receives test code scripts from test code developers for functional blocks on SoCs. For example, test code developers may write debug or test script using coding language such as Java, Python, joint test action group (JTAG), etc., for various functional blocks, such as GPUs, memory controllers, MLUs, etc. In example implementations, the code developers may include one or more docstrings in the test code scripts. For example, a code developer may add a docstring that comments on or characterizes sections of the code scripts. As an example, a docstring may be added to identify sections of the test code script that is public in that these sections may be used by an ML engine to provide code extensions or suggestions to other code developers.

An operation 404 tokenize the test code script to generate test code script vectors. In one implementation, tokenizing the test code script and its corresponding documentation may include converting the corpus of words into numbers based on a predetermined algorithm and then generating vectors of the generated numbers such that distance between various vectors may be determined. According to one implementation disclosed herein, the operation 404 only tokenizes the sections of the test code scripts that are characterized as public by the test code developer. Such decision may be made by analyzing the test code scripts to identify docstrings that my identify sections of the test code scripts as publicly available.

Subsequently, an operation 406 indexes the test code vectors. The operation 406 may index the test code vectors based on number of various indexes. For example, the test code vectors may be indexed based on the type of functional blocks (CPUs, GPUs, etc.) for which the test code scripts are written. Alternatively, the test code vectors may be indexed based on the type of SoCs (mobile device SoC, laptop SoC, etc.) on which the functional blocks are configured.

An operation 408 stores the indexed test code vectors in a test code vector database. For example, such test code vector database may be configured on a cloud and it may receive test code vectors for functional blocks configured on a number of different types of SoCs. Subsequently, an operation 410 may train a LM using the indexed test code vectors.

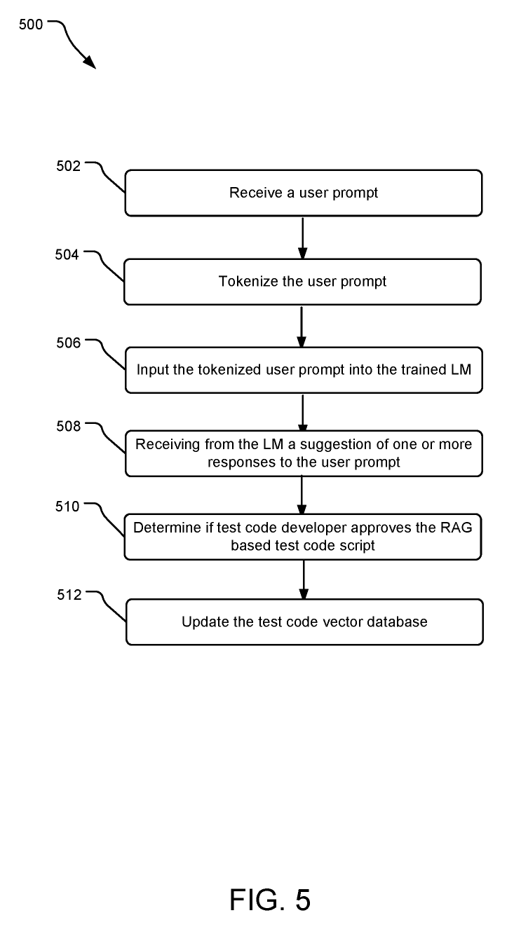

FIG. 5 discloses alternative operations 500 of the AI based hardware debug system disclosed herein. An operation 502 may receive a user prompt. For example, the user prompt may be “generate a test code script for register A on GPU model XYZ.” An operation 504 may tokenize the user prompt. Subsequently, an operation 506 may input the tokenized user prompt into the trained LM. An operation 508 may generate a recommended response to the user using a RAG engine in the manner disclosed above in FIG. 3.

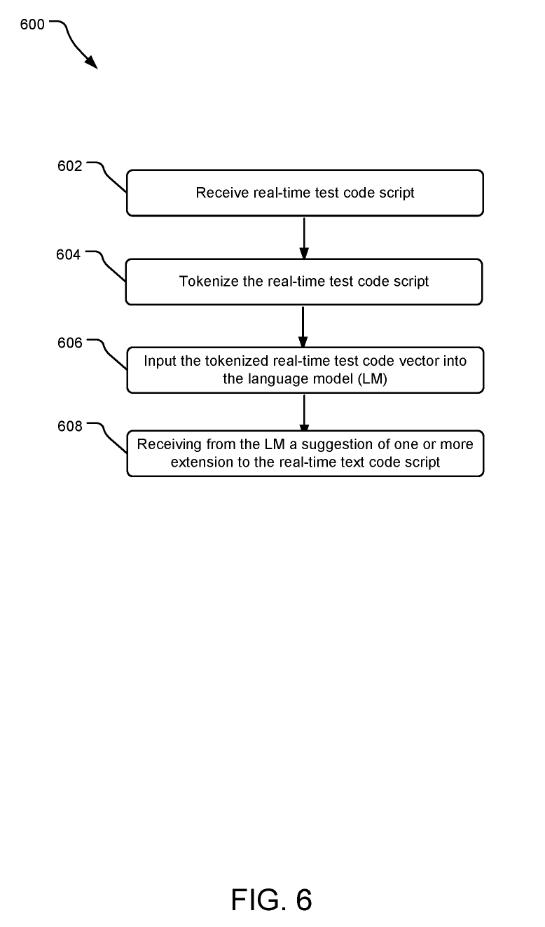

FIG. 6 discloses alternative operations 600 of the AI based hardware debug system disclosed herein. An operation 602 may receive a real-time test code script from a test code developer. An operation 604 may tokenize the real-time test code script. Subsequently, an operation 506 may input the tokenized real-time test code script into the trained LM. An operation 508 may generate a recommended extension to the real-time test code script. Yet alternatively, the operation 508 may generate a recommended correction to the real-time test code script. For example, in one implementation, the operation 508 may generate the correction to the real-time code script using RAG. Subsequently, an operation 510 determines if the test code developer approves the RAG based test code script. If so, an operation 512 updates the test code vector database to include the RAG based test code script.

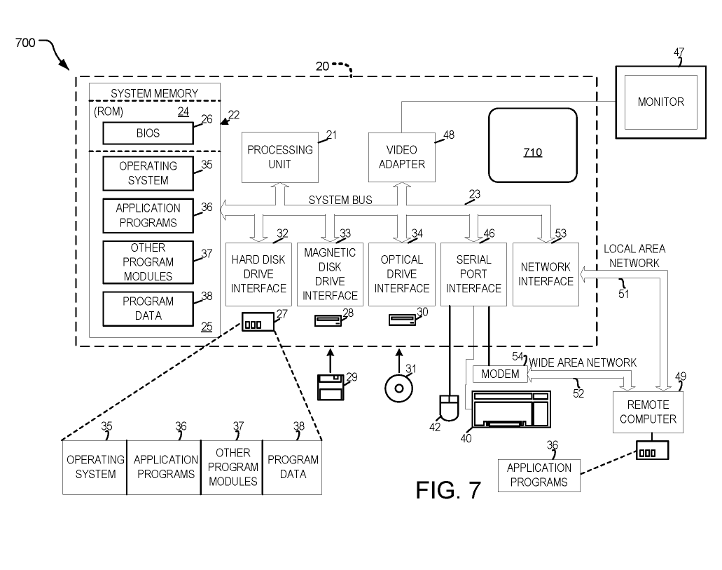

FIG. 7 illustrates an example system 700 that may be useful in implementing the AI based hardware debug system disclosed herein. The example hardware and operating environment of FIG. 7 for implementing the described technology includes a computing device, such as a general-purpose computing device in the form of a computer 20, a mobile telephone, a personal data assistant (PDA), a tablet, smart watch, gaming remote, or other type of computing device. In the implementation of FIG. 7, for example, the computer 20 includes a processing unit 21, a system memory 22, and a system bus 23 that operatively couples various system components, including the system memory 22 to the processing unit 21. There may be only one or there may be more than one processing units 21, such that the processor of a computer 20 comprises a single central-processing unit (CPU), or a plurality of processing units, commonly referred to as a parallel processing environment. The computer 20 may be a conventional computer, a distributed computer, or any other type of computer; the implementations are not so limited.

The system bus 23 may be any of several types of bus structures, including a memory bus or memory controller, a peripheral bus, a switched fabric, point-to-point connections, and a local bus using any of a variety of bus architectures. The system memory 22 may also be referred to as simply the memory and includes read-only memory (ROM) 24 and random-access memory (RAM) 25. A basic input/output system (BIOS) 26, contains the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM, DVD, or other optical media.

The computer 20 may be used to implement the AI based hardware debug system disclosed herein. In one implementation, one or more computer-executable instructions to implement the AI based hardware debug system disclosed herein may be stored in memory of the computer 20, such as the read-only memory (ROM) 24 and random-access memory (RAM) 25.

Furthermore, computer-executable instructions stored on the memory of the computer 20 may be used to Implement the AI based hardware debug system disclosed herein. Similarly, instructions stored on the memory of the computer 20 may also be used to implement one or more operations of the AI based hardware debug system disclosed herein. The memory of the computer 20 may also one or more instructions to implement the AI based hardware debug system disclosed herein.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated tangible computer-readable media provide non-volatile storage of computer-readable instructions, data structures, program modules and other data for the computer 20. It should be appreciated by those skilled in the art that any type of tangible computer-readable media may be used in the example operating environment.

A number of program modules may be stored on the hard disk, magnetic disk 29, optical disk 31, ROM 24, or RAM 25, including an operating system 35, one or more application programs 36, other program modules 37, and program data 38. A user may generate reminders on the personal computer 20 through input devices such as a keyboard 40 and pointing device 42. Other input devices (not shown) may include a microphone (e.g., for voice input), a camera (e.g., for a natural user interface (NUI)), a joystick, a game pad, a satellite dish, a scanner, or the like. These and other input devices are often connected to the processing unit 21 through a serial port interface 46 that is coupled to the system bus 23, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20; the implementations are not limited to a particular type of communications device. The remote computer 49 may be another computer, a server, a router, a network PC, a client, a peer device, or other common network node, and typically includes many or all of the elements described above relative to the computer 20. The logical connections depicted in FIG. 8 include a local-area network (LAN) 51 and a wide-area network (WAN) 52. Such networking environments are commonplace in office networks, enterprise-wide computer networks, intranets, and the Internet, which are all types of networks.

When used in a LAN-networking environment, the computer 20 is connected to the local area network 51 through a network interface or adapter 53, which is one type of communications device. When used in a WAN-networking environment, the computer 20 typically includes a modem 54, a network adapter, a type of communications device, or any other type of communications device for establishing communications over the wide area network 52. The modem 54, which may be internal or external, is connected to the system bus 23 via the serial port interface 46. In a networked environment, program engines depicted relative to the personal computer 20, or portions thereof, may be stored in the remote memory storage device. It is appreciated that the network connections shown are example and other means of communications devices for establishing a communications link between the computers may be used.

In an example implementation, software, or firmware instructions for the AI based hardware debug system 710 may be stored in system memory 22 and/or storage devices 29 or 31 and processed by the processing unit 21. The AI based hardware debug operations and data may be stored in system memory 22 and/or storage devices 29 or 31 as persistent data-stores.

In contrast to tangible computer-readable storage media, intangible computer-readable communication signals may embody computer readable instructions, data structures, program modules or other data resident in a modulated data signal, such as a carrier wave or other signal transport mechanism. The term "modulated data signal" means a signal that has one or more of its characteristics set or changed in such a manner as to encode information in the signal. By way of example, and not limitation, intangible communication signals include wired media such as a wired network or direct-wired connection, and wireless media such as acoustic, RF, infrared and other wireless media.

Some embodiments of AI based hardware debug system may comprise an article of manufacture. An article of manufacture may comprise a tangible storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of the logic may include various software elements, such as software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. In one embodiment, for example, an article of manufacture may store executable computer program instructions that, when executed by a computer, cause the computer to perform methods and/or operations in accordance with the described embodiments. The executable computer program instructions may include any suitable type of code, such as source code, compiled code, interpreted code, executable code, static code, dynamic code, and the like. The executable computer program instructions may be implemented according to a predefined computer language, manner, or syntax, for instructing a computer to perform a certain function. The instructions may be implemented using any suitable high-level, low-level, object-oriented, visual, compiled and/or interpreted programming language.

The AI based hardware debug system disclosed herein may include a variety of tangible computer-readable storage media and intangible computer-readable communication signals. Tangible computer-readable storage can be embodied by any available media that can be accessed by the AI based hardware debug system disclosed herein and includes both volatile and nonvolatile storage media, removable and non-removable storage media. Tangible computer-readable storage media excludes intangible and transitory communications signals and includes volatile and nonvolatile, removable, and non-removable storage media implemented in any method or technology for storage of information such as computer readable instructions, data structures, program modules or other data. Tangible computer-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other tangible medium which can be used to store the desired information, and which can be accessed by the AI based hardware debug system disclosed herein. In contrast to tangible computer-readable storage media, intangible computer-readable communication signals may embody computer readable instructions, data structures, program modules or other data resident in a modulated data signal, such as a carrier wave or other signal transport mechanism. The term "modulated data signal" means a signal that has one or more of its characteristics set or changed in such a manner as to encode information in the signal. By way of example, and not limitation, intangible communication signals include signals moving through wired media such as a wired network or direct- wired connection, and signals moving through wireless media such as acoustic, RF, infrared and other wireless media.

A method disclosed herein provides receiving a test code script for a hardware functional block, tokenizing the test code script to generate a test code vector, indexing the test code vector for storage in a cloud-based test code vector database, inputting the indexed test code vector into a language model (LM), and in response to inputting the test code into the LM, receiving from the LM a suggestion of one or more related code scripts.

A system disclosed herein includes one or more processor units, memory, and an AI based hardware debug system stored in the memory and executable by the one or more processor units, the AI based hardware debug system encoding computer-executable instructions on the memory for executing on the one or more processor units a computer process, the computer process including receiving a test code script for a hardware functional block, tokenizing the test code script to generate a test code vector, indexing the test code vector for storage in a cloud-based test code vector database, inputting the indexed test code vector into a language model (LM), and in response to inputting the test code into the LM, receiving from the LM a suggestion of one or more related code scripts.

One or more tangible computer-readable storage media disclosed herein encodes instructions for executing a computer process, the computer process including receiving a test code script for a hardware functional block, tokenizing the test code script to generate a test code vector, indexing the test code vector for storage in a cloud-based test code vector database, inputting the indexed test code vector into a language model (LM), and in response to inputting the test code into the LM, receiving from the LM a suggestion of one or more related code scripts.

The implementations described herein are implemented as logical steps in one or more computer systems. The logical operations may be implemented (1) as a sequence of processor-implemented steps executing in one or more computer systems and (2) as interconnected machine or circuit modules within one or more computer systems. The implementation is a matter of choice, dependent on the performance requirements of the computer system being utilized. Accordingly, the logical operations making up the implementations described herein are referred to variously as operations, steps, objects, or modules. Furthermore, it should be understood that logical operations may be performed in any order, unless explicitly claimed otherwise or a specific order is inherently necessitated by the claim language.

What is claimed is:

1. A method, comprising:
receiving a test code script for a hardware functional block;
tokenizing the test code script to generate a test code vector;
indexing the test code vector for storage in a cloud-based test code vector database;
inputting the indexed test code vector into a language model (LM); and
in response to inputting the test code into the LM, receiving from the LM a suggestion of one or more related code scripts.

2. The method of claim 1, wherein the test code script includes a docstring including a description of the test code script.

3. The method of claim 2, further comprising categorizing the test code script based on the docstring.

4. The method of claim 2, wherein the docstring includes an availability parameter identifying portions of the test code script as publicly available code that can be shared among a plurality of hardware functional blocks.

5. The method of claim 4, wherein tokenizing the test code script to generate a test code vector further comprising:
evaluating the docstring to determine the portions of the test code script identified as public code; and
indexing portions of the test code script identified as public code.

6. The method of claim 1, further comprising:
receiving a prompt from a test code developer;
using one or more retrieval augmented generative (RAG) AI routines to generate a RAG based test code script based on the prompt from the test code developer;
determining if the test code developer approves the RAG based test code script; and
in response to determining that the test code developer approves the RAG based test code script, updating the test code vector database to include the RAG based test code script.

7. The method of claim 6, further comprising, in response to receiving the prompt, responding to the test code developer based on a search of the test code vector database using the prompt.

8. The method of claim 1, further comprising:
receiving a real-time test code script from a test code developer;
tokenizing the real-time test code script to generate a real-time test code vector;
inputting the tokenized real-time test code vector into the language model (LM); and
in response to inputting the real-time test code vector into the LM, receiving from the LM a suggestion of one or more extension to the real-time text code script.

9. A system comprising:
one or more processor units;
memory; and
an AI based hardware debug system stored in the memory and executable by the one or more processor units, the AI based hardware debug system encoding computer-executable instructions on the memory for executing on the one or more processor units a computer process, the computer process comprising:
receiving a test code script for a hardware functional block;
tokenizing the test code script to generate a test code vector;
indexing the test code vector for storage in a cloud-based test code vector database;
inputting the indexed test code vector into a language model (LM); and
in response to inputting the test code into the LM, receiving from the LM a suggestion of one or more related code scripts.

10. The system of claim 9, wherein the wherein the computer process further comprising:
receiving a real-time test code script from a test code developer;
tokenizing the real-time test code script to generate a real-time test code vector;
inputting the tokenized real-time test code vector into the language model (LM); and
in response to inputting the real-time test code vector into the LM, receiving from the LM a suggestion of one or more extension to the real-time text code script.

11. The system of claim 9, wherein the test code script includes a docstring including a description of the test code script and the computer process further comprising categorizing the test code script based on the docstring.

12. The system of claim 11, wherein the docstring includes an availability parameter identifying portions of the test code script as publicly available code that can be shared among a plurality of hardware functional blocks.

13. The system of claim 12, wherein tokenizing the test code script to generate a test code vector further comprising:
evaluating the docstring to determine the portions of the test code script identified as public code; and
indexing portions of the test code script identified as public code.

14. The system of claim 9, wherein the computer process further comprising:
receiving a prompt from a test code developer;
using one or more retrieval augmented generative (RAG) AI routines to generate a RAG based test code script based on the prompt from the test code developer;
determining if the test code developer approves the RAG based test code script; and
in response to determining that the test code developer approves the RAG based test code script, updating the test code vector database to include the RAG based test code script.

15. The system of claim 14, wherein the computer process further comprising in response to receiving the prompt, responding to the test code developer based on a search of the test code vector database using the prompt.

16. One or more tangible computer-readable storage media encoding instructions for executing a computer process, the computer process comprising:
receiving a test code script for a hardware functional block;
tokenizing the test code script to generate a test code vector;
indexing the test code vector for storage in a cloud-based test code vector database;
inputting the indexed test code vector into a language model (LM); and
in response to inputting the test code into the LM, receiving from the LM a suggestion of one or more related code scripts.

17. The one or more tangible computer-readable storage media of claim 16, wherein the computer process further comprising:
receiving a real-time test code script from a test code developer;
tokenizing the real-time test code script to generate a real-time test code vector;
inputting the tokenized real-time test code vector into the language model (LM); and
in response to inputting the real-time test code vector into the LM, receiving from the LM a suggestion of one or more extension to the real-time text code script.

18. The one or more tangible computer-readable storage media of claim 17, wherein the test code script includes a docstring including a description of the test code script and the computer process further comprising categorizing the test code script based on the docstring.

19. The one or more tangible computer-readable storage media of claim 18, wherein the test code script includes a docstring including a description of the test code script and the computer process further comprising categorizing the test code script based on the docstring.

20. The one or more tangible computer-readable storage media of claim 19, wherein tokenizing the test code script to generate a test code vector further comprising:
evaluating the docstring to determine the portions of the test code script identified as public code; and
indexing portions of the test code script identified as public code.
